(19) United States
(12) Patent Application Publication
(10) Pub. No.: US 2012/0139246 A1
(43) Pub. Date: Jun. 7, 2012

(54) ASYNCHRONOUS GENERATOR SYSTEM AND WIND TURBINE HAVING AN ASYNCHRONOUS GENERATOR SYSTEM

(75) Inventor: Axel Rafoth, Rostock (DE)

(73) Assignee: SUZLON ENERGY GMBH, Rostock (DE)

(21) Appl. No.: 13/389,468

(22) PCT Filed: Aug. 15, 2010
(86) PCT No.: PCT/EP2010/061863

§ 371 Date: Feb. 8, 2012

(30) Foreign Application Priority Data
Aug. 14, 2009 (DE) 10 2009 037 330.6

(51) Int. Cl. H02P 9/08

(52) U.S. Cl. 290/44

(57) ABSTRACT

The present invention relates to an asynchronous generator system for a wind turbine, and a wind turbine with such a system, and the method for operating and starting up such a wind turbine. Herein, the asynchronous generator system is developed especially simply and thus cost-effectively and is able to go through wind storms and the increase of rotational speed associated therewith.

### FIELD OF THE INVENTION

The present invention relates to an asynchronous generator system for a wind turbine, and a wind turbine with such a system, and the method for operating and starting up such a wind turbine. Herein, the asynchronous generator system is developed especially simply and thus cost-effectively and is able to go through wind storms and the increase of rotational speed associated therewith.

### BACKGROUND OF THE INVENTION

It is essentially known that asynchronous generator systems are used for wind turbines to transform kinetic rotational energy of the rotation of a wind turbine, i.e. a rotor, into electrical power. Such asynchronous generator systems usually comprise an asynchronous generator, which comprises a stator and an armature rotatable relatively thereto. Herein, it is possible that, the armature may be an internal, as well as an external armature regarding the stator.

It is also essentially known that asynchronous generator systems are used, especially in wind turbine with high power, i.e. with especially large rotor diameters, which are so-called Doubly Fed Induction Generators (DFIG). In such embodiments, the windings of the stator, as well as the windings of the armature are connected to a grid, which will be fed with power of the wind turbine. These asynchronous generator systems are especially advantageous in the so-called super-synchronous operation, i.e. in an operation, in which the armature rotates faster than the subsequently induced magnetic field in the stator. Currents and thus the available power in the armature generated through the relative movement are also fed into the grid in super-synchronous operation. In order to implement this, such doubly fed induction generator systems comprise their own armature circuit, which can adapt the power, which is generated by the armature in super-synchronous operation, to the grid and to its grid conditions via a frequency converter, i.e. a rectifier and a subsequent inverter. The grid is also fed by the armature circuit. However, a disadvantage of the known asynchronous generator systems is that a very complex construction is necessary in such embodiments. Especially a variety of electronic components are also necessary for connecting the armature, especially its windings, to the grid.

### SUMMARY OF THE INVENTION

The task of the present invention is to solve the above-mentioned disadvantages. Especially the task of the present invention is to provide an asynchronous generator system for a wind turbine, which makes it possible to influence the rotational speed of the rotor of the wind turbine rapidly in an especially easy way, especially more rapidly than that would possibly be by a mechanical adjustment of the rotor blades, the so-called pitching.

This task is solved by an asynchronous generator system with the features of independent claim 1 according to the invention and a wind turbine with the features of independent claim 10. Furthermore, a method for operating a wind turbine with the features of independent claim 11 and a method for starting up a wind turbine with the features of independent claim 12 are also the subjects of the present invention. Further embodiments are given especially from the dependent claims following the respective independent claims.

According to the present invention, an asynchronous generator system for a wind turbine for generating electricity, which is supplied to a grid, comprises herein an asynchronous generator with a stator and an armature. It is not important, whether the armature is arranged inside the stator, or around it, whether the armature is an internal or an external armature. Furthermore, a stator connector is configured, which enables an electrical connection from the windings of the stator to the grid. This stator connector is used as the electrical connection between an asynchronous generator system according to the invention and the grid. This stator connector can be merely functionally developed, for example, by means of cable running leaving away from the stator, but also can be constructed by means of structurally mechanical contacts, especially by means of plug contacts.

Furthermore, an armature connector is configured, which electrically conductive connects the windings of the armature and a power electronic system. Herein, the power electronic system is a system electrically isolated from the grid, and the system forms a circuit of the armature separated from the grid. This power electronic system can therefore be described as an armature circuit, or as an electrical armature circuit, which can not feed power into the grid. The power electronic system electrically isolated from the grid comprises at least one converter, which converts AC current generated in the armature windings. Herein, this converter is dependent on the flowing direction of the current through this converter. In the super-synchronous operation, namely in an operation, in which current generated by the speed difference between the armature and the induced magnetic field in the stator flows through the windings of the armature, the converter operates as a rectifier, which obtains and rectifies the AC current from the windings of the armature. In the reverse operating direction, for example, in the sub-synchronous operation, namely in an operation, in which the armature, i.e. its windings, requires current for supporting, current flows in the opposite direction through the converter and is thus inverted from the DC side to the armature side. Therefore, in this operating situation, the converter works as an inverter.

Furthermore, at least one resistance is configured in the power electronic system, and the at least one resistance is connected downstream of the converter regarding armature connector. In other words, the resistance is arranged on the DC side of the converter. Therefore, it can be summarized, that AC side of the power electronic system is located between the armature connector and the converter, while the DC side is located on the opposite side of the armature connector seeing from the converter. A resistance is arranged in this DC side, through which the current generated by the windings of the armature in the super-synchronous operation flows.

For the case of application that the rotational speed increases at the input of the asynchronous generator systems, i.e. at the connection between the armature and the rotor of the wind turbine, for example, such as what can occur in case of wind storm, the armature of the asynchronous generator will rotate faster. This increase of the rotational speed increases the asynchronicity in the operation state of the asynchronous generator. This would on the one hand lead to a reduction of the efficiency, on the other hand, however, also cause changes on the stator side, so that the desired conditions prescribed by the grid for generating electricity are no longer available at the stator connector. In especially simple and cost-efficient wind turbines, however, a direct coupling to the grid is preferably configured, so that no influence will be exerted on the changes occurred in case of wind storm, on the generated current. In other words, a wind storm would cause fluctuation of the generated power, especially of the generated current flow, which does not conform to the prescribed grid conditions. In the worst case, such a device would not receive approval to be coupled to a grid. Thus the economic efficiency of such a device would no longer exist.

In order to avoid that, additional and expensive electronic components, which can buffer the wind storm, are required on the stator side of the asynchronous generator, in case of such a wind storm the increase of the rotational speed of the rotor of the wind turbine and thus the rotational speed of the armature of the asynchronous generator will be buffered by the present invention in such a way, that the generated current is rectified by the converter and flows through the resistance in the power electronic system electrically isolated from the grid. In other words, the resistance generates a resistance against current flow on the DC side of the converter, which in turn results as a resistance against current flow on the AC side of the armature. Thus, the electrical resistance increases against the increased rotational speed of the armature, whereby the armature is braked. Herein, the additionally generated energy is especially transformed into heat on the resistance and thus is buffered.

In comparison with the known DFIG systems, the power is eliminated in this way, i.e. the power additionally generated in the super-synchronous operation is not fed into the grid but burned out through the resistance. The generation of heat eliminates this additional power, because no grid contact is given. However, in this way the rotational speed can also be kept essentially constant in case of wind storm, without the requirement of additional expensive electronic components, especially on the stator side of the asynchronous generator. Furthermore, the grid connector and the respective requirements for such a connector on the armature side can be avoided. Especially the additional electronic components, for example, an inverter, which would otherwise connect the armature circuit to the grid, can be avoided. All components of the armature are thus independent from the grid and thus can be developed easier.

The above-described procedure of buffering in super-synchronous operation is only temporary. Especially, the buffering is required in the time, which it is required to realize a pitching of the rotor blades. It is related to a rapid reaction to a wind storm, which is followed by a slower reaction, namely the pitching of the rotor blades. If the wind storm is just an especially short wind storm, it can be configured in this way, that the control logic completely omits the mechanical pitching, when the wind storm abates within a certain time period. Unnecessary pitching and thus unnecessary adjusting work on the rotor blades of a wind turbine can be avoided in this way.

Herein, an electrical isolation of the power electronic system from the grid can be so understood, that the power electronic system comprises no electrical connection to the grid. In other words, the armature circuit is electrically separated from the grid. Such an electrical separation is especially a complete electrical isolation, in which there exists no indirect connection, for example, connection to the grid through the transformers.

The resistance in the power electronic system is advantageously switchable. In the simplest meaning, this switching is switching on and off a resistance. By combining multiple resistances and/or inductors, different resistance values can be therefore generated on the DC side of the converter of the power electronic system, and the different resistance values are adapted for the corresponding different super-synchronous operation types, i.e. the corresponding wind storm with different strengths. A plurality of resistances can generate the desired or the necessary resistance value by purposely switching on a certain number of resistances in case of the corresponding wind storms, i.e. the corresponding super-synchronous operation.

Wherein, the stator connector and the armature connector are understood especially as an electrical connector, such as what is necessary in a corresponding situation. For example, this could be a three-phase connector at the stator connector, which is connected in star or delta connection. On the armature side this can also be a three-phase or a two-phase connector, which leads the AC current from the armature, especially from its windings, to the converter. The connector for DC on the DC side of the converter can therefore advantageously be implemented as a two-phase connector.

Wherein, in a power electronic system according to the present invention, the resistance can be differently configured. It may be an ohmic resistance, an inductive resistance or a capacitive reactance.

It can be summarized that in an asynchronous generator system according to the invention, it is avoided that additional power will be fed into the grid from the armature circuit. In other words, the additional power is not supplied to the grid but somewhat eliminated. Only through this step, i.e. through the acceptance of the elimination of the generated power, it is possible to enable the especially simple construction manner of an asynchronous generator system according to the present invention. Especially, by the possible isolation of the armature circuit from the grid in this way, the armature circuit can be developed much easier apparently, especially the second converter, i.e. the inverter towards the grid, can be avoided.

In the context of the present invention, it can be advantageous, if the at least one resistance is a variable resistance, whose resistance value is variable. The resistance value, usually given in the unit Ohm [Ω], is especially variable from zero up to a maximum value. The variability can be implemented stepwise or essentially continuously. A stepwise variability of a single resistance can also be achieved by connecting several resistances to each other, especially by their parallel connection and the possibility of being switch on and off separately. The variability of the resistance results in that a specific reaction of the power electronic system to the corresponding wind storm can be realized. The greater the wind storm is, the stronger the acceleration of the rotor blades and therefore the higher the rotational speed of the armature in the asynchronous generator is. Thus the power of inner windings of the armature will correspondingly highly increase according to the strength of the wind storm. The more the power increases, the greater, i.e. the higher the resistance value can be configured when a resistance is variable, so that the resistance can be adapted, especially proportionally to the strength of the wind storm and thus the concomitant increase of the rotational speed of the armature. The additional power of the armature dissipated, i.e. eliminated, by the resistance is automatically, or purposely controlled, or regulated to be adapted to the respective strength of the wind storm. Therefore, the flexibility of a so configured asynchronous generator system is reinforced.

Furthermore, it can be advantageous if a DC voltage measuring device is configured, which is connected downstream of the converter in the asynchronous generator system, and which is developed in such a manner, that the DC voltage connected downstream of the converter can be measured. Such a DC voltage measuring device is used to measure the voltage generated at the output of the converter on the DC side. This voltage is in direct correlation with the corresponding current, or with the generated power in the windings of the armature. If the generated power increases, or the rotational speed of the armature and thus the super-synchronicity of the asynchronous generator increases, the measured voltage in the DC circuit, i.e. the measured DC voltage after the converter also increases.

The DC voltage measuring device is used to determine a value, which directly reflects the voltage on the DC side of the converter, and indirectly contains information about synchronicity or the strength of the super-synchronicity of the armature of the asynchronous generator. Such information can be especially forwarded to a control device and it will be used either for controlling or for regulating, or even for displaying this information or the situation. It is especially meaningful if a variable resistance, as it has been explained above, is used. Thus, the above-determined DC voltage value on the DC side of the converter can be used to control for the controlling or regulating of the variation of the resistance value of the variable resistance of the power electronic system.

Therefore, it is meaningful, if a resistance control device is configured in the context of the invention, and the resistance control device is developed in such a manner, that the DC voltage measured by the DC voltage measuring device can be evaluated. The resistance value of the at least one resistance is varied according to this evaluation. Here, the resistance value of a sum of resistances, which are especially connected in parallel, can also be changed. In other words, based on the measured DC voltage, it is possible either to switch on or off a defined number of resistances connected in parallel, or to adjust a variable resistance in such a way, that the desired resistance value could be generated. In this way, it is possible to control a servo loop, which is located between the input value of the DC voltage and the output value of the adjusted resistance. The input value of the DC voltage represents here an information about the super-synchronicity of the armature in the asynchronous generator, while the output value of the resistance value includes the corresponding buffering of the power generated by the super-synchronicity in the armature circuit. The control is implemented for buffering the fast wind storms, without the requirement of pitching of the rotor blades of a wind turbine.

Furthermore, it can be advantageous, if at least one DC source, which is connected downstream of the converter regarding the armature connector, is configured in the asynchronous generator system according to the invention. This DC source can supply the armature with power via the converter. In this case, the power supply is implemented from the DC side of the converter to the AC side, i.e. in the direction of the armature or in the direction of the armature connector. So in this case the converter operates as an inverter. Especially, such a situation will occur, when the armature of the asynchronous generator is in the sub-synchronous operation. In such a case, the armature rotates more slowly than the corresponding electrically induced magnetic field on the stator side of the asynchronous generator. Thus, the DC source supports the armature especially in sub-synchronous operation of the armature.

In addition, the DC source can also be used for the starting procedure of the asynchronous generator system. In asynchronous generators, it is necessary to achieve a magnetization especially of the stator, i.e. the field excitation. This is usually ensured by the removal of idle power from the grid. However, since the removal of idle power from the grid is undesirable for the grid operators, in this case this field excitation can be ensured by providing a DC source, without removing of idle power from the grid. In this way, the power, which is sufficient for exciting the field in the asynchronous generator, will be provided by the DC source. The asynchronous generator will be connected to the grid, only when the rotor of the wind turbine has reached a sufficient speed, especially the rotational speed of the rotor and thus also the rotational speed of the armature in the asynchronous generator is above a value, which meets the required grid conditions. Until then, any support of the armature and of the stator, especially the necessary field excitation can be fed by the DC source. In comparison with known wind turbines, additional electronic components, especially a soft starter for asynchronous generator can thus be avoided. The startup procedure and the components necessary for the startup procedure are therefore easier and thus less expensive comparing with the known systems.

It can be advantageous, if the DC source is a DC accumulator in the asynchronous generator system according to the invention. The accumulation of DC can be carried out in different ways. So it is possible to configure a classic battery, for example, a lithium-ion battery. For the DC accumulator it is also possible to configure a capacitive accumulator, for example, in the form of capacitors. The DC source in the form of a DC accumulator has the advantage that it makes more easily to implement the isolation from the grid. A simple separation from additional accumulator grids is possible unconditionally in case of a DC accumulator, while otherwise in case of a DC source other sources are needed.

Especially, it can be advantageous, if the DC source in the form of a DC accumulator in an asynchronous generator system according to the invention can be charged independently from the grid. The charge is thus implemented completely isolated, i.e. separated from the grid just as well as the construction of the power electronic system. Herein, the charge can be implemented for example directly using energy generated by the armature. As mentioned above, additional power will be fed from the armature in the super-synchronous operation into the armature circuit. This is converted by the converter in the form of power, so that a current flow is generated on the DC side of the converter. This can be used to charge the battery. In other words, this embodiment further has the advantage that not all the power is eliminated by the resistance in the super-synchronous operation, but partial thereof is stored in the battery, especially until the full charge status of the battery. According to the present invention, it is also possible to charge using separate means, such as photovoltaic, i.e. small solar panel. Especially, the combination of regenerated energy, i.e. the arrangement of solar panels, for example, on the pulpit of a wind turbine, can be advantageous for charging the battery. It is essential, that in all embodiments the independence of the armature circuit from the grid, i.e. its electrical insulation will be kept.

Furthermore, it can be advantageous in an asynchronous generator system according to the invention, if at least one of the electronic components, which are connected downstream of the armature, is integrated in the armature. This means that at least one of the downstream connected electronic components is part of the armature, i.e. the electronic component rotates together with the armature. Especially the embodiments are advantageously provided here, which do not comprise DC source, especially do not comprise battery. The great advantage of such integration is that by using the required slip rings, the electrical contact between the rotating armature and non-rotating components, i.e. the non-rotating electrical components can be avoided. The absence of slip rings has the advantage that it significantly increases the freedom from maintenance or the low ratio of maintenance of such an asynchronous generator system. However, this is possible with an increase of the necessary volume for the asynchronous generator system, especially for the armature. Although the armature is enlarged, it increases the freedom from maintenance or the low ratio of maintenance of such an asynchronous generator system. Especially freedom from maintenance or the low ratio of maintenance is a great advantage in the operational areas of the wind turbine which are difficult to be accessed, such as in so-called off-shore facility on the high sea.

It can also be advantageous, if a frequency measuring device is configured between the converter and the armature connector, and the frequency measuring device is connected with a pulse width modulator in a manner of control technique, which can predetermine pulse widths for the converter. In other words, the corresponding AC frequency on the AC side of converter is measured in this way. By predetermining the pulse width by a pulse width modulator this can be influenced depending on the measured frequency. A defined support of the armature can be implemented in this way, in defined frequency conditions, especially during the starting operation or in the sub-synchronous operation of the armature, i.e. in an operation, in which the converter works as an inverter and preferably the current, i.e. the power is supplied by the current source. It is advantageous to configure a regulate path between the frequency measuring device and the pulse width modulator to connect to the converter, that the support of the armature can be improved in starting operation as well as in sub-synchronous operation.

A further subject of the present invention is a wind turbine with an asynchronous generator system according to the invention, as well as a rotor, which is coupled with the armature of the asynchronous generator in a torque-locked manner. The stator of the asynchronous generator in the wind turbine is mounted in a torque-proof manner regarding to the armature of the asynchronous generator. The rotor of the wind turbine comprises several rotor blades, which are arranged around a common rotor axis, and serve as working surface for the wind. The individual blades move the whole rotor around its bearing axis and thus the rotor shaft in rotation. The torque-locked coupling of the rotor shaft of the rotor, i.e. of the rotor with the armature of the asynchronous generator, can be implemented both directly and indirectly. Indirect couplings are often preferred, because a gear can be used in this way, which can implement a rotational speed modulation between the rotational speed of the rotor and the desired rotational speed of the armature. Such a gear can be both switchable, i.e. variable, and fixed.

Especially simple designs use fixed gear ratios, so as to make it unnecessary to switch the gear. Especially a switching of the gear can be avoided by using an asynchronous generator system according to the invention, since in some areas the rotational speed of the armature can be sufficiently influenced by configuring the resistance in the power electronic system of the asynchronous generator system. Further mechanical components torque-locked coupling the rotor with the armature is also considerable. It is possible to configure couplings, which enable a complete coupling and uncoupling of the rotor with the armature of the asynchronous generator. The advantages of a wind turbine according to the invention are identical with the advantages described already by using an asynchronous generator system according to the invention.

A further object of the present invention is a method of operating a wind turbine as mentioned above. Wherein in case of under voltage in the connected grid, the asynchronous generator system of the wind turbine supports the grid by supplying idle power. This can be achieved, for example, by implementing such idle power support on the stator side, i.e. in the range of the stator connector of the stator of the asynchronous generator using additional capacitor banks, especially small capacitor banks. Furthermore, it is assured that in such a case, the wind turbine, especially the asynchronous generator does not draw any idle power from the grid and thus the grid would be weaker. This can be ensured especially by configuring a DC source, which enables the field excitation in the asynchronous generator in such a case and thus provides its own idle power.

A further subject of the present invention is a method of starting a wind turbine according to the present invention. Wherein after the rotor of the wind turbine and thus also the armature of the asynchronous generator are started up to a predefined rotational speed, at least one resistance is connected to limit the current. Then the connection of windings of the stator to the grid via the stator connector is implemented. Subsequently, the resistance can be especially reduced again. As already detailed mentioned, the rotational speed of the armature can be influenced within limits by the resistance. Especially, the status of super-synchronicity can be influenced in this way. By using the method according to the invention, a soft starter or a bypass contactor can be especially avoided, since the starting currents in the armature as well as in the stator are limited by the resistance.

Especially, the invention relates to an asynchronous generator system for variable rotational speed operation and for the controlled power output of a wind turbine. For the application of the asynchronous generators in the wind turbines, it is especially known, that the asynchronous generators are so far preferably used as asynchronous generators directly coupled to the grid and used as doubly fed induction generators (DFIG).

Besides, disadvantageously, in these systems, the system-conditioned harmonic frequencies in the armature current haven been proved, that they can cause the disruptive reactions on the public supply grid with AC voltage and lead to undesirable power swings on the grid side. The problem of idle power supplied from the grid is also known, such as the case in which asynchronous machines are directly coupled to the grid. This idle power is undesirable for energy supply. For this reason a large number of wind turbines operate according to the so-called “Danish Principle”, which configures expensive power electronic systems in a wind turbine for compensating the idle power demand, i.e. for the specific excitation of the generators.

It is also advantageous to be able to control the rotational speed of a wind turbine according to the incoming wind volume, wherein the frequency of the generated electric energy is essentially constant.

Herein, a known solution, especially for asynchronous machines, is a concept, in which a variable resistance in the armature circuit of the generator allows a momentary increase or decrease of the rotational speed. Complete rotational speed variation of an asynchronous machine is achieved by a doubly-fed induction generator (DFIG), wherein the armature is connected to the power supply grid via a DC circuit and two converters. Wherein, the disadvantage is presented that these converter systems are expensive and error-prone and furthermore, disruptive reactions can also be caused on the power supply grid by the generation of harmonic frequencies.

The present invention should avoid the disadvantages of asynchronous generators in wind turbines according to the prior art, and especially improve the systems advantageously according to the above-mentioned type DFIG and the above-described concept. One of the main goals of the invention is to regulate the effective and idle power fed into the grid and besides to reach an increased variability of the rotational speed of the armature.

A possible embodiment of the invention therefore provides an asynchronous generator system with an armature and a stator surrounding the armature, wherein additionally a power electronic system is configured in the armature circuit in such a way, that a variable resistance, especially, variable resistance having resistive, inductive and/or capacitive nature, is formed therein. Thus, the generator system will be configured to be able to provide the idle power required by the generator. The power electronic system, which can work as a converter, can be configured as IGBT bridge (1), as shown in FIG. 1, which comprises a DC circuit (2) and a chopper. The IGBT Bridge (1) replaces advantageously the diode circuits, which have been so far used in similar generator systems. Therefore, for compensating the idle power to achieve the corresponding magnetization for the exciting of the generator, in the described embodiment, the expensive power electronic circuits can be avoided, which utilize capacitors for generating a corresponding magnetic flows in the stator and as they were usually in capacitor excited generator systems in the prior art.

An important point of the invention is that an energy generation only occurs in the super-synchronous operation, in the generator operation. According to each connected load, the possible rotational speed range can be adjusted by the slip and thus the power factor of the equipment, under which the system can be driven, can be adjusted. This is especially advantageous in highly variable wind conditions, since it also allows an adapted power production and additionally protects the equipment components against overload.

In another embodiment of the generator system according to the invention, the feed of the loss can be implemented by the idle power compensation from the excessive energy of the armature. What should be mentioned as a further advantage of the generator system according to the invention is that the circuit according to the invention makes it possible to realize a switching-on procedure through a synchronization procedure in the way corresponding to a synchronous generator. In this way, a smooth connection between the system and the grid is guaranteed. In addition the commonly used soft starter and the associated by-pass contactor can be therefore avoided.

### BRIEF DESCRIPTION OF DRAWINGS

The present invention will be further described referring to the accompanying figures. The concepts “left”, “right,” “up” and “down” used here refer to an orientation of the figures with normally readable reference numbers. In the drawings:

FIG. 1 shows the circuit diagram of an embodiment of the asynchronous generator system according to the invention;

FIG. 2 shows a schematic illustration of a wind turbine according to the invention;

FIG. 3 shows a schematic diagram in case of buffering a wind storm.

### DETAILED DESCRIPTION OF EMBODIMENTS

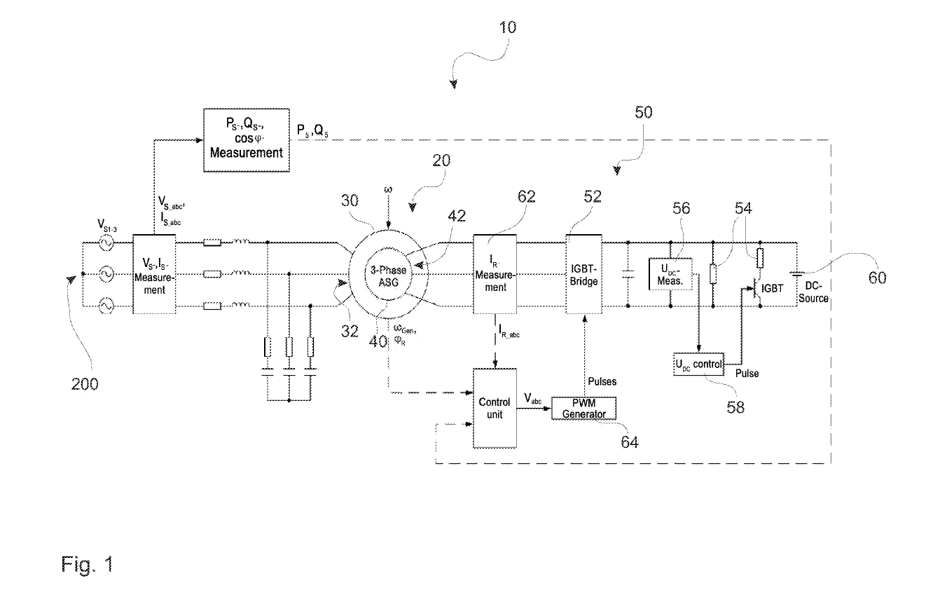

In FIG. 1, an embodiment of an asynchronous generator system 10 according to the invention is shown schematically. An asynchronous generator 20 is configured in the center of this asynchronous generator system 10, and the asynchronous generator 20 comprises a stator 30 and a rotor 40. A three-phase stator connector 32 is configured on the stator side of the stator 30. This stator connector 32 is used to connect the stator 30 to the grid 200. In addition, all three phases are connected with a small capacitor bank via three resistances, so that the grid can be supported by this capacitor, in case of a grid variation, i.e. a drop of the grid voltage, for example in LVRT case (low voltage ride through).

An armature connector 42 is configured likewise three-phase on the armature side of the asynchronous generator 20. The three phases of the armature connector 42 are connected to a converter 52, which is configured as so called IGBT bridge (insulated-gate bipolar transistor). In the case that the asynchronous generator 20 operates in super-synchronous operation, power is generated in the armature 40, which is supplied to the converter 52 via the armature connector 42. The incoming AC is rectified in the converter 42 and provided to the DC circuit on the DC side of the converter. In this case, DC on the right side of the converter 52 in FIG. 1 flows through two resistances 54, which are used for buffering the additional power in the super-synchronous operation of the armature 40.

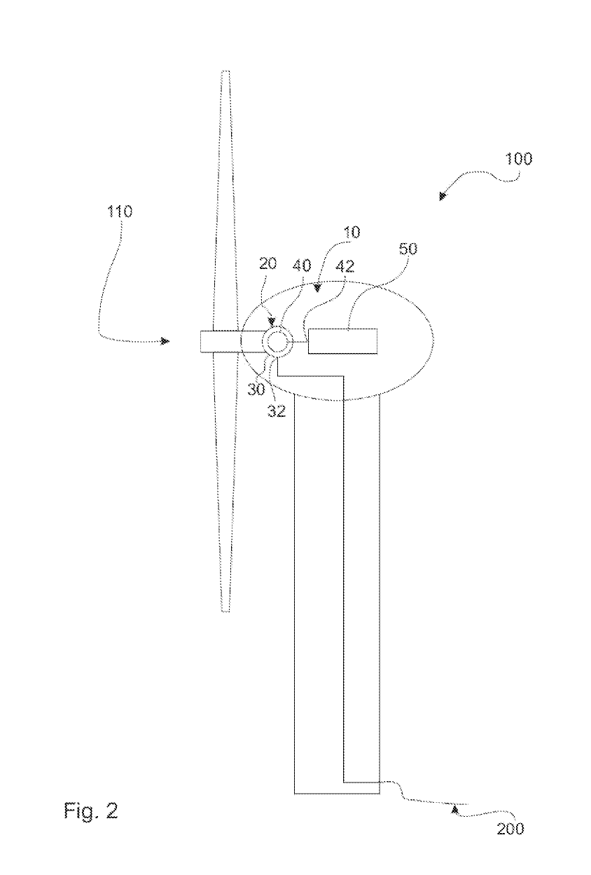

Furthermore, in the embodiment of FIG. 2 it can be seen that a frequency measuring device 62 is configured between the armature connector 42 and the converter 52. This frequency measuring device 62 is connected with a pulse width modulator 64 via a control unit. In turn, this pulse width modulator 64 can send pulse signals to the converter 52, so that the converter can modulate the corresponding pulse width and thus the corresponding frequency of the generated AC in inverter operation, i.e. in an operation, in which power must be provided to the armature 40. This operation is especially available, when current source 60 is used, which is likewise configured in the DC circuit on the right side of the converter 52. In the present embodiment, herein the DC source 60 is implemented either as a capacitor or as a battery. This battery can be especially charged by the additional power in case of a super-synchronous operation of the armature 40 in the DC circuit on the right side of the converter 52.

As it can be clearly seen in FIG. 1, the armature circuit, i.e. especially the basic correlation of armature connector 42, frequency measuring device 62, converter 52, resistances 54 and battery, i.e. DC source 60, is a closed current system, which is completely electrically isolated especially from the grid 200. By means of this electrical isolation, it is possible to implement armature circuit especially easily, and especially, to avoid connector components which are otherwise necessary for the connection components to the grid 200.

Furthermore, a DC voltage measuring device 56 is configured in the armature circuit on the right side of the converter 52, i.e. on its DC side. This is in turn connected to a resistance control device 58, which can vary the variable resistances 54 or one variable resistance of the two resistances 54 regarding its resistance value via a signal connection. As explained in detail, since the measured DC voltage of the DC voltage measuring device 56 comprises information about the super-synchronicity of the armature 40 of the asynchronous generator 20, the necessary power buffered by the resistance 54 and thus the necessary expected resistance value can be determined in this way. Thus a variable buffering of the power will be implemented by the feedback of the DC voltage measurement, using the adjustment of the variation of resistances 54, according to the corresponding super-synchronicity of the armature 40 in the asynchronous generator 20.

FIG. 2 shows an embodiment of a wind turbine 100 according to the invention. The wind turbine 100 comprises a rotor 110, which is schematically shown. The rotor shaft of the rotor 110 leads into the inside of a pulpit of the wind turbine 100, in which the asynchronous generator system 10 of the present invention is configured. The asynchronous generator 20 and the power electronic system 50 are schematically shown in the asynchronous generator system 10. The connection between them both is implemented via the armature connector 42 on the armature 40. The power electronic system 50 can be implemented for example in such a way, as it has been explained in the embodiment of FIG. 1. Furthermore, a stator connector is configured on the stator 30 of the asynchronous generator 20, which is connected with the grid 200 via an electrically conductive connection. Power is supplied to the grid, i.e. fed into it, via this electrically conductive connection.

It is also well shown in the FIG. 2, that the power electronic system 50 is a system completely isolated from the grid 200. This arrangement of electronic components in the power electronic system 50 is thus separated from the grid 200 and can be therefore implemented especially easily and therefore cost-effective.

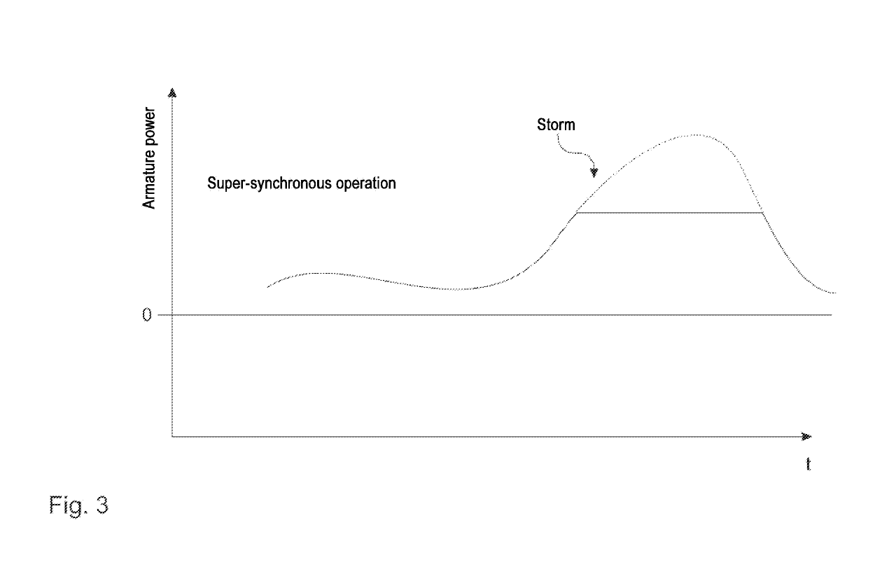

The operating manner of a power electronic system 50 according to the invention will be briefly explained referring to FIG. 3. The armature power is illustrated here on the Y-axis in a diagram, and thus the rotational speed of the armature is also illustrated indirectly. A curve of the armature power is shown over the time on the x-axis. The armature power is either greater or lower than zero in the basic operation. When the power is greater than zero, i.e. power is generated in the armature, it is the super-synchronous operation, i.e. an operation, in which the armature rotates faster, i.e. having a higher rotational speed than that for the case of the induced magnetic field in the stator. In this super-synchronous operation power is generated in the armature.

In the case that a wind storm meets the rotor 110 of a wind turbine 100, for example as it is shown in FIG. 2, not only the rotor rotational speed of the rotor 110 of the wind turbine 100, but also the rotational speed of the armature 40 of the asynchronous 20 coupled by a gear will increase. The related power of the armature also increases, as it can be seen on the right part along the time axis in FIG. 3. The storm results in an increase of the armature power and thus an increase of the rotational speed, which in turn results in a reduction of efficiency regarding the power on the stator side of the asynchronous generator 20. To prevent this, the resistance 54 will be switched on upon a determined increase of the power of the armature, or the variation of the resistance 54 will be adapted to the increase of power of the armature. In other words, in FIG. 3, the armature power is reduced by the elimination of energy, for example by the heat of the resistances. Therefore, the characteristic curve of the armature power in the cases of wind storms without resistance 54 is shown in dashed lines in FIG. 3, while the actual curve after the reduction essentially goes along a line parallel to the time axis during the storm. If the storm is short enough, as it is the case in the situation shown in FIG. 3, then it is not necessary for mechanical pitching or adjusting the rotor blades of the rotor 110 of the wind turbine 100. In fact, it is sufficient if a short time buffering can be implemented by the resistances 54 of the power electronic system 100 in such a case.

Furthermore, the generator system, as FIG. 1 shows, comprises one or more resistances 54 in the armature circuit. This can be implemented as an ordinary load resistance with a controllable resistance, for example, in the form of an IGBT component, in the described embodiment. The resistance or resistances 54 can be varied in their value according to the load and besides have the task to dissipate the power on the armature side. The system according to the invention is different from the systems of the prior art, which leads the system power back to the grid via a second converter connected on the grid side, especially via a controllable inverter. This converter can be saved in the present invention, so that the manufacturing costs can be reduced. Therefore, a second converter can be avoided explicitly, whereby the concept of double-fed induction machine (DIFG) can be simulated with the help of the controllable resistances 54 and the IGBT Bridge. Furthermore, the system according to the invention reduces power swings of the generator 20 and harmonic frequencies (fluctuation) in the armature current, which has a negative impact on the power supply grid 200, which is connected to the generator system 20.

Furthermore, the circuit according to the invention comprises a battery 60. Besides, the battery 60 has the task to deliver power to the system 10, especially to feed energy for the armature 40 of the equipment, when the grid voltage falls. The battery 60 can be so configured, that it is automatically charged when a corresponding power supply voltage is provided for example by an energy source connected on the battery 60.

In the embodiment of the circuit according to the invention according to FIG. 1, there is also a control and regulation unit, which processes the corresponding signals of the generator 20, such as frequency/rotational speed, of a measuring unit 62, which obtains the current value of the armature current, and of a power measuring unit for obtaining an effective and idle power or power factor as input parameters and generates an output signal. This output signal is provided to a connected pulse width modulator PWM 64 for generating pulse signals. These pulse signals are fed into the electronic power system 50, so as to control its performance according to the operating performance of the generator system 10. In addition, the circuit according to the invention comprises a voltage measuring unit 56 and a measuring—and controlling unit 58 in the DC circuit for obtaining and regulating a DC voltage, so as to be able to regulate the resistance 54 in the armature circuit. In this way, the illustrated embodiment of the invention describes a feedback control system, which also allows regulating and adjusting the idle power according to the requirements for the operating performance of the machine with variable loads, which can occur especially in the variable wind conditions in the environment of the wind turbine 100.

The above-described embodiments are merely exemplary embodiments. Certainly, these can be combined with each other especially with respect to individual components, if it is technically meaningful.

Reference list

| | |
|---|---|
| 10 | asynchronous generator system |
| 20 | asynchronous generator |
| 30 | stator |
| 32 | stator connector |
| 40 | armature |
| 42 | armature connector |
| 50 | power electronic system |
| 52 | converter |
| 54 | resistance |
| 56 | DC voltage measuring device |
| 58 | resistance control device |
| 60 | DC source |
| 62 | frequency measuring device |
| 64 | pulse width modulator |
| 100 | wind turbine |
| 110 | rotor of a wind turbine |
| 200 | grid |

1. An asynchronous generator system (10) for a wind turbine for generating electricity, which is provided to a grid (200),
wherein an asynchronous generator (20) is configured with a stator (30) and an armature (40), comprising
a stator connector (32) for an electrically conductive connection between the windings of the stator (30) and the grid (200) and
an armature connector (42) for an electrically conductive connection between the windings of the armature (40) and a power electronic system (50),
wherein the power electronic system (50) is electrically isolated from the grid (200) and comprises a converter (52), which converts a current generated in the windings of the armature, and at least one resistance (54) is further configured, which is connected downstream of the converter (52) regarding the armature connector (42).

2. An asynchronous generator system (10) according to claim 1, wherein at least one resistance (54) is a variable resistance, whose resistance value is variable.

3. An asynchronous generator system (10) according to claim 2, wherein a DC voltage measuring device (56) is configured to be connected downstream of the converter (52), the DC voltage measuring device (56) is so arranged, that the DC voltage connected downstream of the converter (52) can be thus measured.

4. An asynchronous generator system (10) according to claim 3, wherein a resistance control device (58) is configured, which is so arranged, that it can evaluate the DC voltage measured by the DC voltage measuring device (56) and varies the resistance value of the at least one resistance (52) depending on this evaluation.

5. An asynchronous generator system (10) according to claim 1, wherein at least one DC source (60) is configured to be connected downstream of the converter (52) regarding the armature connector (42), the DC source can supply power to the armature (40) via the converter (52).

6. An asynchronous generator system (10) according to claim 5, wherein the DC source (60) is a DC accumulator.

7. An asynchronous generator system (10) according to claim 6, wherein the DC source (60) in the form of a DC accumulator can be charged independently from the grid (200).

8. An asynchronous generator system (10) according to claim 1, wherein at least one of the electronic components connected downstream of the armature connector (42) is integrated in the armature (40).

9. An asynchronous generator system (10) according to claim 1, wherein a frequency measuring device (62) is configured between the converter (52) and the armature connector (42), and the frequency measuring device (62) is connected with a pulse width modulator (64) in a manner of control technique, which can predetermine pulse widths for the converter (52).

10. The wind turbine (100) comprising an asynchronous generator system (10) with the features of claim 1 and a rotor (110), which is coupled with the armature (40) of the asynchronous generator (20) in a torque-locked manner, wherein the stator (30) of the asynchronous generator (20) in the wind turbine (100) is mounted in a torque-proof manner regarding the armature (40) of the asynchronous generator (20).

11. The method of operating a wind turbine (100) with the features of claim 10, wherein in case of under voltage in the connected grid (200), the asynchronous generator system (10) of the wind turbine (100) supports the grid (200) by feeding idle power.

12. The method of starting a wind turbine (100) with the features of claim 10, wherein after the rotor (110) of the wind turbine (100) and thus also the armature (40) of the asynchronous generator system (20) are started up to a predefined rotational speed, at least one resistance (54) is connected to limit the current and then the connection of the windings of the stator (30) to the grid (200) via the stator connector (32) is implemented.
